(19) United States
(12) Patent Application Publication
(10) Pub. No.: US 2011/0290992 A1
(43) Pub. Date: Dec. 1, 2011

(54) SYSTEM AND METHOD OF OPTICAL MEASUREMENTS FOR WELLBORE SURVEY

(75) Inventors: Shigeru SATO, Tokyo (JP); Tsutomu YAMATE, Yokohama-Shi (JP)

(73) Assignee: Schlumberger Technology Corporation, Sugar Land, TX (US)

(21) Appl. No.: 12/789,466

(22) Filed: May 28, 2010

(51) Int. Cl. G01V 5/04

(52) U.S. Cl. 250/253

(57) ABSTRACT

A system of optical measurements for wellbore survey comprises a light conveyable cable, an optical measurement apparatus optically coupled to one end of the light conveyable cable, and a light source optically coupled to another end of the light conveyable cable. The light source produces light used for optical measurements in the optical measurement apparatus.

### FIELD OF THE INVENTION

The present invention relates generally to optical measurements for wellbore survey. More specifically, some aspects disclosed herein are directed to systems and method of optical measurements using light output from a light source for wellbore surveys such as wellbore trajectory measurements, azimuth measurements and navigation in boreholes.

### BACKGROUND OF THE INVENTION

An optical measurement apparatus including a light source has been proposed for measurements of various parameters for wellbore surveys during WireLine (“WL”) logging operations, Logging-While-Drilling (“LWD”) operations and Measurement-While-Drilling (“MWD”) operations. For example, a continuous MWD survey apparatus including two fiber optic gyroscopes (“FOG”) together with three accelerometers is disclosed in U.S. Pat. No. 6,668,465 which is incorporated herein by reference in its entirety. One of the FOGs is sensitive to rotation about a tool spin axis of a bottom hole assembly (“BHA”) and another FOG is sensitive to rotation of the BHA about an axis normal to the tool spin axis. The three accelerometers generate three acceleration signals representing the components of the BHA along three mutually orthogonal axes. The outputs of the FOGs are processed together with acceleration signals from the three accelerometers in a processor which determines the orientation, velocity and position of the BHA on a continuous basis.

In the wellbore survey using the optical measurement apparatus such as the FOG, a light source installed in the optical measurement apparatus is subjected to wide temperature range from room temperature to about 100° C. or more under downhole. The operation in the wide temperature range impairs the performance such as lifetime, stability and output luminance of the light source. For example, the continuous operation in the high temperature range degrades output luminance and lifetime of the light source. In addition, in the wellbore the BHA cannot be always at a constant temperature. The temperature is rather always changing because the temperature usually increases with the depth increasing. Output signals from the FOG are sensitive to thermal drift of wavelength of the light from the light source because the output of phase difference (Δθ) due to Sagnac effect is directly related to the wavelength (λ) as well as input rotation rate (Ω) as indicated in the following equation (1):

$$Δ θ = \frac{4 π La}{c λ} \cdot Ω \qquad ( 1 )$$

where L is a length of a sensing coil (optical fiber) used in the FOG, c is the velocity of light and a is an average radius of the sensing coil. In the case of SLD (Super Luminescent Diode) used for a light source, typical value of temperature sensitivity of wavelength is approximately 0.25 nm/K, which corresponds to phase drift of 235 ppm/K at 1060 nm and 200 ppm/K at 1300 nm. Usually, residual errors after FOG calibration are in ppm order. So, these phase drifts are not acceptable. In addition, it is difficult to control temperature of the light source disposed in wellbore under the ground, because a temperature control device such as a Peltier device can not function effectively due to high ambient temperature over 100° C. in environment around the light source in the wellbore.

Furthermore, a separate-type FOG having a sensing coil (fiber optic loop) and an optical directional coupling device connected to the sensing coil via two polarization maintaining optical fibers is disclosed in Japanese Published Unexamined Patent Application No. S63-300907 and “Development of Precision Fiber-Optic Gyro for Marine Gyrocompass System”, S. Nakamura, The Review of Laser Engineering, Vol. 26 (1998), No. 4, p. 320. In this separate-type FOG, the optical directional coupling device is deployed in a control room apart from the sensing coil. Lightwaves from a light source are split by the optical directional coupling device and passes through the polarization maintaining optical fibers to the sensing coil. The lightwaves output from the sensing coil return to the optical directional coupling device by passing through the polarization maintaining optical fibers and are coupled to each other to measure Sagnac phase shift. In wellbore survey application using the separate-type FOG, the polarization maintaining optical fibers are located in a wellbore and may be subjected to harsh environment such as wide temperature/pressure ranges, mechanical vibrations and so on. The Sagnac phase shift measurements are affected by phase shift errors and/or phase noise generated in the polarization maintaining optical fibers due to the harsh environment. Therefore, it is difficult to obtain stable and accurate output from the separate-type FOG in wellbore survey application.

As described above, it is difficult to obtain stable and accurate output from the optical measurement apparatus under the ground in wide temperature range. Therefore, there is a need to perform accurate measurements for wellbore survey using an optical measurement apparatus even if such optical measurement apparatus is used, for example, in oilfield and any other harsh environment in wide temperature range.

As will become apparent from the following description and discussion, the present invention provides an improved method and system capable of operating stably and accurately under the ground in a wide temperature range.

### BRIEF SUMMARY OF THE INVENTION

In one aspect of the present invention, a system of optical measurements for wellbore survey comprises a light conveyable cable extending into a wellbore from outside the wellbore, an optical measurement apparatus optically coupled to one end of the light conveyable cable and deployed inside the wellbore, and a light source optically coupled to another end of the light conveyable cable and deployed outside the wellbore. The light source produces light used for optical measurements in the optical measurement apparatus.

In aspects herein, the light source may output phase-coherent light, and the optical measurement apparatus may be at least one optical gyroscope using the phase-coherent light conveyed via the light conveyable cable from the light source. In addition, the optical gyroscope may be a fiber optic gyroscope using at least one optical fiber coil. The fiber optic gyroscope may be a closed loop fiber optic gyroscope. Furthermore, the optical fiber coil may comprise a polarization maintaining optical fiber, and the light conveyable cable may comprise a single-mode optical fiber. Moreover, the optical measurement apparatus may comprise two or more optical gyroscopes and a light splitter for splitting light from the light conveyable cable to the optical gyroscopes.

In aspects disclosed herein, the light source may comprise at least one of an SLD (Super Luminescent Diode) and an EDFA (Erbium Doped Fiber Amplifier). In addition, the system may comprise an optical power converting unit for converting light power of a part of the light received from the light conveyable cable to electrical power used for an electrical circuit in the optical measurement apparatus.

In aspects herein, the system may comprise a data transmitting unit for transmitting light modulated based on data generated in the optical measurement apparatus, via the light conveyable cable. Furthermore, the light output from the light source may include one or more wavelengths of near infrared. The one or more wavelengths may include at least one of a first wavelength of approximately 850 nm, a second wavelength of approximately 1060 nm, a third wavelength of approximately 1300 nm, and a fourth wavelength of approximately 1550 μm. Moreover, the system may comprise a temperature controller for controlling temperature of the light source at a predetermined temperature. The light source may be deployed on the ground, on the bottom of the sea, or in the sea.

In yet another aspect of the present invention, the disclosure provides a method of an optical measurement for wellbore survey. The method comprises deploying a light source outside a wellbore, the a light source being coupled to one end of a light conveyable cable; deploying an optical measurement apparatus inside the wellbore by paying out the light conveyable cable, the optical measurement apparatus being coupled to another end of the light conveyable cable; and performing an optical measurement with the optical measurement apparatus using light output from the light source and conveyed via the light conveyable cable.

Additional advantages and novel features of the invention will be set forth in the description which follows or may be learned by those skilled in the art through reading the materials herein or practicing the invention. The advantages of the invention may be achieved through the means recited in the attached claims.

### BRIEF DESCRIPTION OF THE DRAWINGS

The accompanying drawings illustrate preferred embodiments of the present invention and are a part of the specification. Together with the following description, the drawings demonstrate and explain principles of the present invention.

FIG. 1 is an illustration of one exemplary system of optical measurements for wellbore survey according to the disclosure herein;

FIG. 2 is a schematic diagram of one exemplary signal processor for a closed loop type FOG according to the disclosure herein;

FIG. 3 is an illustration of another exemplary system of optical measurements for wellbore survey according to the disclosure herein; and

FIG. 4 is an illustration of one exemplary method of optical measurements for wellbore survey using the above-described FOG apparatus according to the disclosure herein.

Throughout the drawings, identical reference numbers indicate similar, but not necessarily identical elements. While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the scope of the invention as defined by the appended claims.

### DETAILED DESCRIPTION OF THE INVENTION

Illustrative embodiments and aspects of the present disclosure are described below. In the interest of clarity, not all features of an actual implementation are described in the specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such development effort might be complex and time-consuming, but would nevertheless be a routine undertaking for those of ordinary skill in the art having benefit of the disclosure herein.

In one of exemplary applications of a System for wellbore survey using an optical measurement apparatus according to the disclosure herein, the system comprises a light source, a logging cable as a light conveyable cable including a optical fiber, and at least one fiber optic gyroscope (FOG) apparatus as a optical measurement apparatus used in a wellbore. The FOG apparatus is optically coupled to one end of the optical fiber implemented in the logging cable. The FOG apparatus includes a fiber coupler (optical directional coupler), a polarizer, a sensing coil (fiber optic loop), an optical phase modulator, a photo detector, and a signal processor, as described in U.S. Pat. Nos. 5,062,710, 5,278,631, 5,283,626, 6,028,668, 7,295,322, and ending U.S. patent application Ser. No. 12/236,644, which are incorporated herein by reference in its entirety. The FOG apparatus is installed within a downhole tool such as a wireline logging tool and a drilling tool used for oil field operations to determine the azimuth and trajectory of the downhole tool in a wellbore. In the case of strap-down configuration, the sensing coil of FOG apparatus is rigidly fixed at a predetermined position of a body member such as a chassis of the downhole tool. The light source is optically coupled to another end of the optical fiber and produces light used in the FOG apparatus. The light output from the light source is conveyed to the FOG apparatus via the optical fiber in the logging cable. The light source is installed in a surface equipment deployed on the ground where the ambient temperature of the light source can be controlled at a predetermined constant temperature so as to reduce a drift of wavelength of the output light from the light source. Therefore, the present system can supply the stable light to the FOG apparatus in the wellbore and perform accurate measurements using the FOG apparatus in oilfield and any other harsh environment in a wide temperature range more than 100° C.

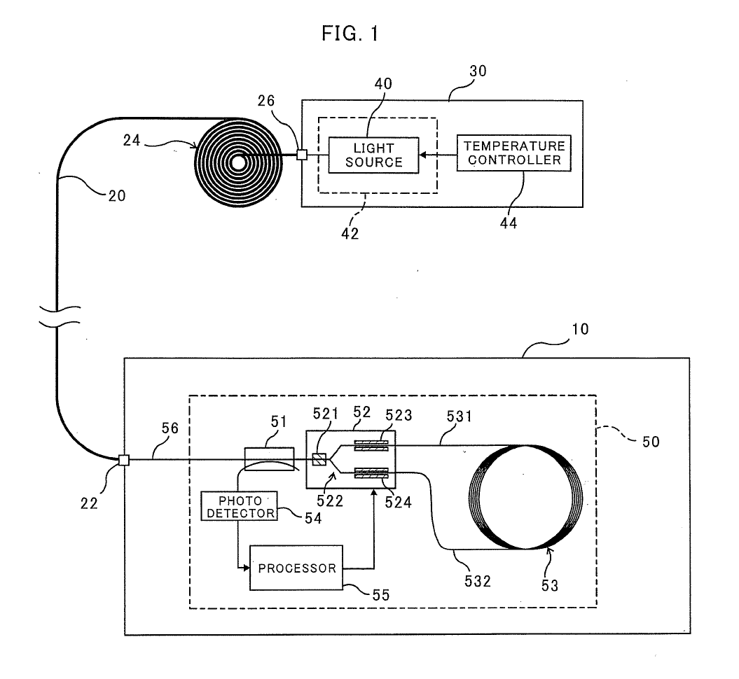

Referring to FIG. 1, there is shown a schematic illustration of one exemplary system of optical measurements for wellbore survey using an FOG apparatus according to the disclosure herein. The system includes a downhole tool 10 movable up and down within a wellbore drilled into the ground. The downhole tool 10 is connected to a downhole cable 20 via an upper termination 22 so that the downhole tool 10 is suspended by the downhole cable 20. The downhole cable 20 is partially wound on a cable drum 24 and connected to a surface equipment 30 via a upper termination 26 on the ground. The downhole cable 20 includes an optical fiber for conveying light for optical measurements from a light source 32 in the surface equipment 30 to an FOG apparatus 50 in the downhole tool 10. The downhole cable 20 also includes transmission lines so as to allow to transmit signals electrically or optically between the FOG apparatus 50 in the downhole tool 10 and the surface equipment 30.

The light source 40 outputs phase-coherent light having high-luminance and relatively low coherency, i.e. having shorter coherent length than a predetermined length so as to reduce output drifts of the FOG apparatus due to optical error factors such as light scattering, variation of polarization planes, the Kerr effect. The light source 40 may include at least one of an SLD (Super Luminescent Diode) and an EDFA (Erbium Doped Fiber Amplifier) to produce phase-coherent light with high-luminance and relatively low coherency.

There is several wavelengths in near infrared range having low propagation loss through the optical fiber, which are generally called as “transparency windows”. Table 1 shows some examples of the transparency windows. In Table 1, typical values of optical attenuation rate (dB/m), optimal fiber length (Lop) as trade-off between Sagnac phase shift (Δθ) and optical attenuation, and optical output power from a light source, at specific wavelengths in near infrared. The light source is a butterfly module of SLD (Super Luminescent Diode) obtained from Anritsu Corporation in Japan.

TABLE 1

| | | | | | | | | |
|---|---|---|---|---|---|---|---|---|
| Wavelength | 850 | nm | 1060 | nm | 1300 | nm | 1550 | nm |
| Attenuation | 2 | dB/m | 1 | dB/m | 0.4 | dB/m | 0.025 | dB/m |
| Lop | 4 | km | 8 | km | 20 | km | 35 | km |

| | | | | | | | |
|---|---|---|---|---|---|---|---|
| SLD power | 2 | mW/ | — | 14 | mW/ | 25 | mW/ |
| | 120 | mA | | 400 | mA | 500 | mA |

The Sagnac phase shift (Δθ) decreases in inverse proportion to wavelength λ as indicated in aforementioned equation (1). On the other hand, the signal/noise ratio (S/N) increases in proportion as increasing wavelength λ because the number of photons increases with wavelength λ increasing for a given power. Furthermore, output power from the SLD and optical attenuation of the optical fiber are better with wavelength λ increasing. Suppose, for instance, that the total length of optical fiber including FOG sensing coil is 10 km and wavelength λ is 1300 nm, and compare with the case of wavelength of 850 nm, the Sagnac phase shift (Δθ) is 1/1.5 (=0.67) times, the S/N is 1.2 times, the optical attenuation is 0.2 times, and the output optical power from SLD is 7 times. Loss of the Sagnac phase shift (Δθ) can be compensated with other merits, i.e., the larger S/N, the less optical attenuation, and the larger output optical power from SLD.

Considering the transparency windows for optical fibers in longer wavelength of near infrared, in which the advantages can be obtained in regard to the S/N, optical attenuation and output optical power from the light source, the light output from the light source 40 may include one or more wavelengths of near infrared having low propagation loss through the optical fiber used in the downhole cable. The one or more wavelengths in the near infrared rage may include at least one of a first wavelength of approximately 850 nm, a second wavelength of approximately 1060 nm, a third wavelength of approximately 1300 nm, and a fourth wavelength of approximately 1550 nm.

The light source 40 may be disposed in a thermostatic chamber 42 and temperature of the light source 40 in the chamber 42 may be controlled at a predetermined temperature by a temperature controller 44 so that the wavelength of light output from the light source 40 is stable during operation of downhole tool 10.

The optical fiber in the downhole cable 20 may be a single-mode optical fiber, neither polarization maintaining (PM) or non-polarization maintaining, which supports two polarization modes. The optical fiber may be conveyable the near infrared light having wavelength of approximately 850 nm, 1060 nm, 1300 nm or 1550 nm with low propagation loss.

The FOG apparatus 50 in the downhole tool 10 includes a PM fiber coupler 51 as an optical directional coupler, a FOG chip 52 as an integrated optic circuit, a PM fiber coil 53 as a sensing coil which forms an optical pass, a photo detector 54, and a processor 55. The PM fiber coupler 51 and the lower termination 22 of the downhole cable 20 are connected with a PM optical fiber 56. Both end portions 531 and 532 of the PM fiber coil 53 are connected to the FOG chip 52. The FOG chip 52 includes a polarizer 521, a Y-shaped waveguide 522 as an optical coupler, phase modulators 523, 524 formed with electrodes. The FOG chip 52 has an input port (disposed toward the PM fiber coupler 51) and two output ports (disposed toward the PM fiber coil 53).

Lightwaves from the light source 40 passing through the PM fiber coupler 51 are subsequently polarized by the polarizer 521 in the FOG chip 52. The polarized lightwaves are split into two substantially equal parts at a joint of the waveguide 522; one propagates as a right-handed light in the clockwise (CW) direction through the PM fiber coil 53, and the other propagates as a left-handed light in the counter-clockwise (CCW) direction through the PM fiber coil 53.

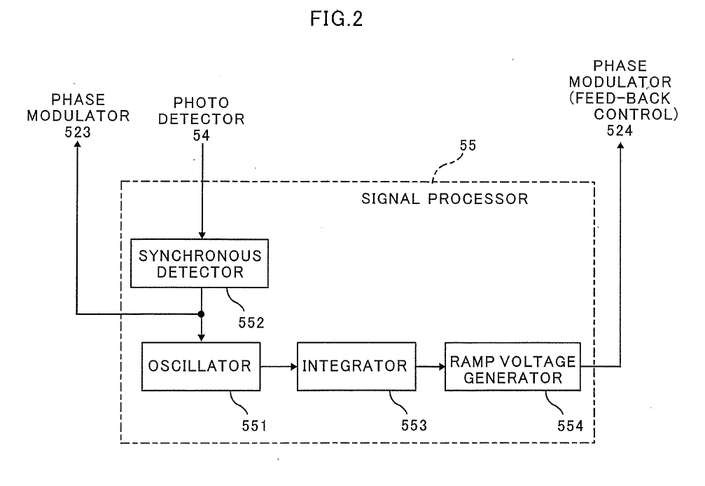

FIG. 2 shows a schematic diagram of one exemplary signal processor for a closed loop type FOG according to the disclosure herein. The CW and CCW lightwaves, which propagate through the PM fiber coil 53, are phase modulated by the output of an oscillator 551 in the phase modulator 523. The CW and CCW lightwaves thus phase modulated are coupled together by the waveguide 522 and interfere with each other, thereafter being applied again via the polarizer 521 and the PM fiber coupler 51 to a photo detector 54 which serves as photoelectric conversion means. The interference light having thus reached the photo detector 54 is converted into an electrical signal, which is applied to a synchronous detector 552, wherein the same component as the phase modulation frequency is extracted from the signal. The output of the synchronous detector 552 is integrated by an integrator 553, and a ramp voltage of a frequency corresponding to the integrated output is generated by a ramp voltage generator 554. The ramp voltage is used to control the phase modulator 524 as a feedback phase generator (phase difference generator). The phase modulator 524 provides a phase difference between the CW and CCW lightwaves and is controlled by the negative feedback thereto of the ramp voltage so that the phase difference between the CW and CCW lightwaves is reduced to zero. By measuring the frequency f of the ramp voltage from the following equation (2), the input angular velocity Ω of the FOG apparatus 50 can be obtained as described in U.S. Pat. No. 5,062,710,

$$f = \frac{2 R}{n λ k} \cdot Ω \qquad ( 2 )$$

where R is the radius of the PM fiber coil 53, n is the refractive index of the PM fiber coil 53, λ is the wavelength of light supplied from the light source 40, and k is an integer representing the maximum phase shift by the ramp voltage.

In this embodiment of the system disclosed in FIG. 1, the FOG apparatus 50 may further include an optical power converting unit for converting light power of a part of the light received from the optical fiber in the downhole cable 20 to electrical power used for electrical circuits in the FOG apparatus 50. In addition, the FOG apparatus 50 may further include a data transmitting unit for transmitting light modulated based on data generated in the FOG apparatus 50, via the optical fiber in the downhole cable 20. Each of the optical power converting unit and the data transmitting unit may be installed as a discrete unit in the downhole tool 10 instead of mounting in the FOG apparatus 50.

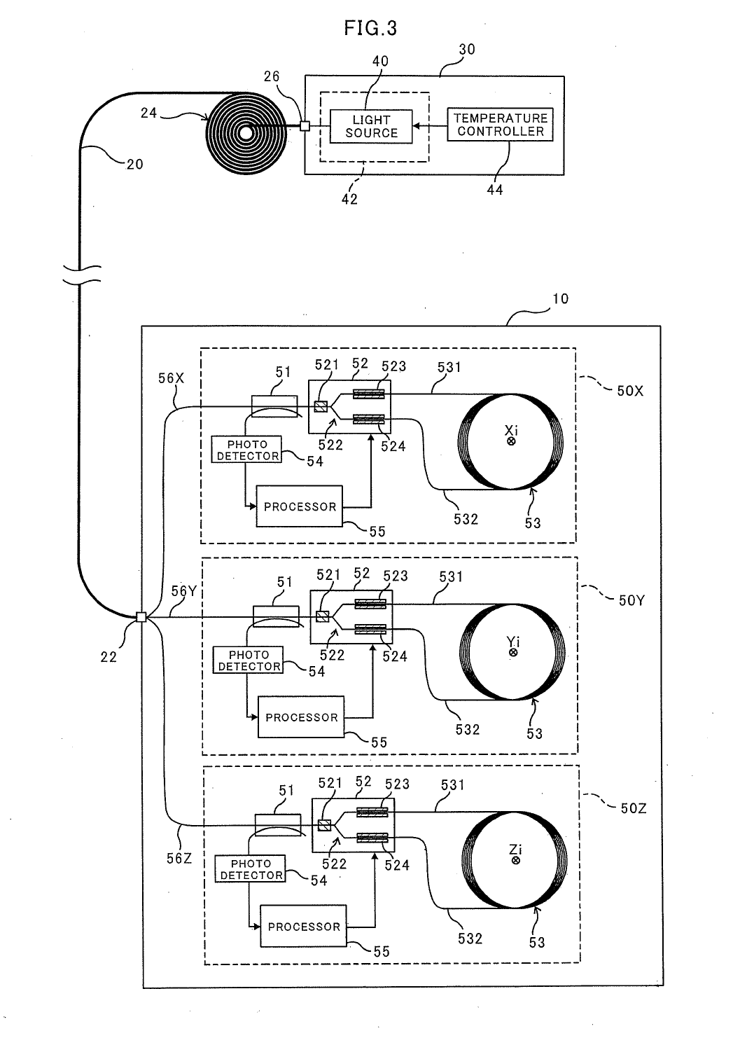

FIG. 3 illustrates another exemplary system of optical measurements for wellbore survey according to the disclosure herein. This system includes three FOG apparatuses 50X, 50Y, 50Z for measurements of rotation rates. The three FOG apparatuses 50X, 50Y, 50Z are oriented orthogonally respective to each other and mounted in orthogonal triads of a housing of the downhole tool 10. The input axes Xi, Yi, Zi of the FOG apparatuses 50X, 50Y, 50Z are set to be oriented orthogonally respective to each other based on an orthogonal body coordinate system (Xb, Yb, Zb). The body coordinate system can be defined within the housing such that the X-axis (Xb) is upward, the Y-axis (Yb) is left-hand, and the Z-axis (Zb) is forward. The lower termination 22 of the downhole cable 20 include an optical splitter which splits the polarized lightwaves from the optical fiber in the downhole cable 20 into three substantially equal parts for the optical fibers 56X, 56Y, 56Z of the FOG apparatuses 50X, 50Y, 50Z respectively. Each of the FOG apparatuses 50X, 50Y, 50Z can be configured as the same as the FOG apparatus according to the above-described embodiment in FIGS. 1 and 2.

Three accelerometers may be included in this embodiment of the system for azimuth measurements and other navigation applications in the wellbore together with the FOG apparatus. The accelerometers are oriented orthogonally respective to each other and mounted within the housing of the downhole tool 10. The detection axes of the accelerometers are set to be oriented orthogonally respective to each other based on the body coordinate system.

The output data of rotation rate measured by the above-described FOG apparatus 50 (50X, 50Y, 50Z) in FIGS. 1-3 may be used for azimuth measurements in various wellbore survey operations such as LWD, MWD and WL logging, and for determining attitude and/or position of a wellbore tool such as a wireline logging tool and a drilling tool for navigation in various well bore operations, as described in pending U.S. patent application Ser. No. 12/233,592 filed on 19 Sep. 2008 and co-pending and commonly owned U.S. patent application Ser. No. 12/503,075 filed on 15 Jul. 2009. These U.S. patent application Ser. Nos. 12/233,592 and 12/503,075 are incorporated herein by reference in its entirety.

In the embodiments shown in FIGS. 1-3, the sensing portion including the PM fiber coil 53 of the FOG apparatus 50 may be rotated by a driving mechanism using at least one motor and transmission gears, as described in pending U.S. patent application Ser. No. 12/240,943 filed on Sep. 29, 2008. The U.S. patent application of No. 12/240,943 is incorporated herein by reference in its entirety.

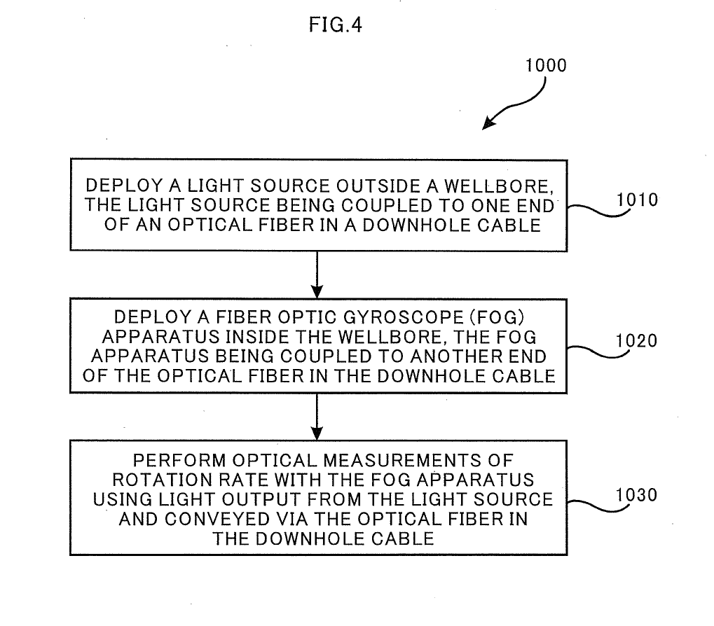

FIG. 4 illustrates one embodiment of a method of optical measurements for wellbore survey using the above-described FOG apparatus according to the disclosure herein. The method 1000 begins by deploying a light source 40 in a surface equipment 30 on the ground, i.e. outside a wellbore, as set forth in the box 1010. The light source 40 is coupled to one end of an optical fiber in a downhole cable 20. The method 1000 continues, as set forth in the boxes 1020, by deploying a fiber optic gyroscope (FOG) apparatus 50 inside the wellbore by paying out the downhole cable 20 from the cable drum 24. The FOG apparatus 50 is installed in the downhole tool 10 and coupled to another end of the optical fiber in the downhole cable 20. Then, as set forth in the box 1030, the method 1000 concludes, in this particular embodiment, by performing optical measurements of rotation rate with the FOG apparatus 50 using light output from the light source 40 and conveyed via the optical fiber in the downhole cable 20.

The preceding description has been presented only to illustrate and describe certain embodiments. It is not intended to be exhaustive or to limit the invention to any precise form disclosed. Many modifications and variations are possible in light of the above teaching.

The embodiments and aspects were chosen and described in order to best explain principles of the invention and its practical applications. The preceding description is intended to enable others skilled in the art to best utilize the principles in various embodiments and aspects and with various modifications as are suited to the particular use contemplated. It is intended that the scope of the invention be defined by the following claims.

1. A system of optical measurements for wellbore survey comprising:
a light conveyable cable extending into a wellbore from outside the wellbore;
an optical measurement apparatus optically coupled to one end of the light conveyable cable and deployed inside the wellbore, wherein the optical measurement apparatus is configured to determine a rotation rate thereof; and
a light source optically coupled to another end of the light conveyable cable and deployed outside the wellbore in a thermostatic condition.

2. The system according to claim 1, wherein
the light source outputs phase-coherent light, and
the optical measurement apparatus is at least one optical gyroscope using the phase-coherent light conveyed via the light conveyable cable from the light source.

3. The system according to claim 2, wherein the optical gyroscope is a fiber optic gyroscope using at least one optical fiber coil.

4. The system according to claim 3, wherein the fiber optic gyroscope is a closed loop fiber optic gyroscope.

5. The system according to claim 3, wherein
the optical fiber coil comprises a polarization maintaining optical fiber, and
the light conveyable cable comprises a single-mode optical fiber.

6. The system according to claim 2, wherein the optical measurement apparatus comprises two or more optical gyroscopes and a light splitter for splitting light from the light conveyable cable to the optical gyroscopes.

7. The system according to claim 1, wherein the light source comprises at least one of an SLD (Super Luminescent Diode) and an EDFA (Erbium Doped Fiber Amplifier).

8. The system according to claim 1, further comprising an optical power converting unit for converting light power of a part of the light received from the light conveyable cable to electrical power used for an electrical circuit in the optical measurement apparatus.

9. The system according to claim 1, further comprising a data transmitting unit for transmitting light modulated based on data generated in the optical measurement apparatus, via the light conveyable cable.

10. The system according to claim 1, wherein the light output from the light source includes one or more wavelengths of near infrared.

11. The system according to claim 10, wherein the one or more wavelengths includes at least one of a first wavelength of approximately 850 nm, a second wavelength of approximately 1060 μm, a third wavelength of approximately 1300 nm, and a fourth wavelength of 1550 nm.

12. The system according to claim 1, further comprising a temperature controller for controlling temperature of the light source at a predetermined temperature.

13. The system according to claim 1, wherein the light source is deployed on the ground, on the bottom of the sea, or in the sea.

14. A method of an optical measurement for wellbore survey comprising:
deploying a light source outside a wellbore, the light source being coupled to one end of a light conveyable cable in a thermostatic condition, the light source outputting phase-coherent light, and the light conveyable cable comprising a single-mode optical fiber;
deploying an optical measurement apparatus inside the wellbore by paying out the light conveyable cable, the optical measurement apparatus being coupled to another end of the light conveyable cable, the optical measurement apparatus being at least one optical gyroscope using the phase-coherent light conveyed via the light conveyable cable from the light source, the optical gyroscope being a fiber optic gyroscope using at least one optical fiber coil, and the optical fiber coil comprising a polarization maintaining optical fiber; and
performing an optical measurement with the optical measurement apparatus using light output from the light source and conveyed via the light conveyable cable, whereby the optical measurement determines a rotation rate of the optical measurement apparatus.
